(19) United States
(12) Patent Application Publication
(10) Pub. No.: US 2026/0278298 A1
(43) Pub. Date: Sep. 17, 2026

(54) CONVERSATION INFORMATION PROCESSING METHOD, ELECTRONIC DEVICE AND STORAGE MEDIUM

(71) Applicants: Beijing Zitiao Network Technology Co., Ltd., Beijing (CN); BYTEDANCE TECHNOLOGY LTD., Grand Cayman (KY)

(72) Inventors: Lei LIU, Beijing (CN); Bin LI, Beijing (CN); Tianjie CHEN, Beijing (CN); Wenjie FU, Beijing (CN); Zhiyao XIA, Beijing (CN); Lin OU, Beijing (CN); Lingmin LIN, Beijing (CN); Wencheng ZHANG, Beijing (CN); Lingjie LUO, Beijing (CN); Shuping WANG, Beijing (CN); Meng LI, Beijing (CN); Jindong HONG, Hong Kong (CN); Yijun HE, Beijing (CN)

(21) Appl. No.: 19/569,686

(22) Filed: Mar. 17, 2026

(30) Foreign Application Priority Data
Mar. 17, 2025 (CN) 202510315846.2

(51) Int. Cl. G06F 40/40

(52) U.S. Cl. CPC G06F 40/40

(57) ABSTRACT

The present disclosure relates to a conversation information processing method, an electronic device and a storage medium. The method includes: determining whether a target conversation is over; inputting, in response to the target conversation being over, first prompt information and the target conversation into a conversation summarization model to obtain a plurality of candidate summary results, where the first prompt information includes a conversation summary outline; and determining a target summary result based on the plurality of candidate summary results and the target conversation.

### CROSS-REFERENCE TO RELATED APPLICATION

This application claims the priority to and benefits of the Chinese Patent Application, No. 202510315846.2, which was filed on Mar. 17, 2025. The aforementioned patent application is hereby incorporated by reference in its entirety.

### TECHNICAL FIELD

The present disclosure relates to the field of artificial intelligence technologies, and in particular, to a conversation information processing method, an electronic device and a storage medium.

### BACKGROUND

In many applications of today's information processing, it is often necessary to summarize conversation contents. Most of the existing conversation information processing functions adopt a template-based summarization manner. Specifically, a template includes a plurality of slots, and key information is missing in the slots. When summarizing the conversation content, the key information for filling the slots is first extracted from the conversation text, and then the extracted key information is filled into the slots of the template, thereby obtaining a structured summary report.

The existing conversation information processing method has many problems. For example, for different conversation scenarios, appropriate templates need to be set. For example, in a diabetes consultation scenario, a template needs to include relevant slots such as blood sugar control, diet and exercise habits, etc.; while in a heart disease consultation scenario, a template needs to include relevant slots such as a heart disease type, recent attack symptoms, daily medication, etc. In addition, this conversation information processing manner is difficult to adapt to various user expressions, resulting in deviations in keyword extraction, which in turn leads to incomprehensive or inaccurate summary reports.

### SUMMARY

In order to solve the above technical problems or at least partially solve the above technical problems, the present disclosure provides a conversation information processing method and apparatus, an electronic device, and a storage medium.

In a first aspect, the present disclosure provides a conversation information processing method, including: determining whether a target conversation (e.g., a first conversation) is over; inputting, in response to the target conversation being over, first prompt information and the target conversation into a conversation summarization model to obtain a plurality of candidate summary results, the first prompt information including a conversation summary outline; and determining a target summary result (e.g., a first summary result) based on the plurality of candidate summary results and the target conversation.

In a second aspect, the present disclosure further provides a conversation information processing apparatus, including: a judgment module, configured to determine whether a target conversation is over; a summarization module, configured to input, in response to the target conversation being over, first prompt information and the target conversation into a conversation summarization model to obtain a plurality of candidate summary results, the first prompt information including an outline of a conversation summary result; and a determination module, configured to determine a target summary result based on the plurality of candidate summary results and the target conversation.

In a third aspect, the present disclosure further provides an electronic device, including: one or more processors; and a storage apparatus, configured to store one or more programs, when the one or more programs are executed by the one or more processors, the one or more processors are caused to implement the conversation information processing method according to the above first aspect.

In a fourth aspect, the present disclosure further provides a computer-readable storage medium storing a computer program, and when the computer program is executed by a processor, the processor is caused to implement the conversation information processing method according to the above first aspect.

Compared with the prior art, the technical solutions provided by embodiments of the present disclosure have the following advantages: according to the technical solutions provided by embodiments of the present disclosure, it is determined whether a target conversation is over; in response to the target conversation being over, first prompt information and the target conversation are input into a conversation summarization model to obtain a plurality of candidate summary results, the first prompt information including a conversation summary outline; and a target summary result is determined based on the plurality of candidate summary results and the target conversation. According to the technical solution provided by the present disclosure, the language understanding ability of a large language model is used to summarize conversation content. According to this solution, the purpose of summarization may be conveniently and quickly realized without setting complex summary templates for different conversation scenarios. Moreover, the provided target summary result has a high correlation and accuracy with the target conversation, and covers the content of the target conversation more comprehensively.

### BRIEF DESCRIPTION OF DRAWINGS

The drawings herein, which are incorporated in and constitute a part of this specification, illustrate embodiments consistent with the present disclosure and, together with the description, serve to explain the principles of the present disclosure.

In order to more clearly explain the technical solutions in the embodiments of the present disclosure or in the prior art, the drawings required in the description of the embodiments or the prior art will be briefly introduced below. Obviously, for those of ordinary skill in the art, other drawings may be obtained according to these drawings without paying creative efforts.

FIG. 1 is a flowchart of a conversation information processing method provided by at least one embodiment of the present disclosure;

FIG. 2 is a schematic structural diagram of a conversation information processing apparatus provided by at least one embodiment of the present disclosure; and

FIG. 3 is a schematic structural diagram of an electronic device provided by at least one embodiment of the present disclosure.

### DETAILED DESCRIPTION

In order to understand the above objects, features and advantages of the present disclosure more clearly, the solutions of the present disclosure will be further described below. It should be noted that, in case of no conflict, the features in one embodiment or in different embodiments may be combined.

Many specific details are set forth in the following description to facilitate a full understanding of the present disclosure, but the present disclosure may also be implemented in other ways different from those described herein. Obviously, the described embodiments are part of the embodiments of the present disclosure, but not all of the embodiments.

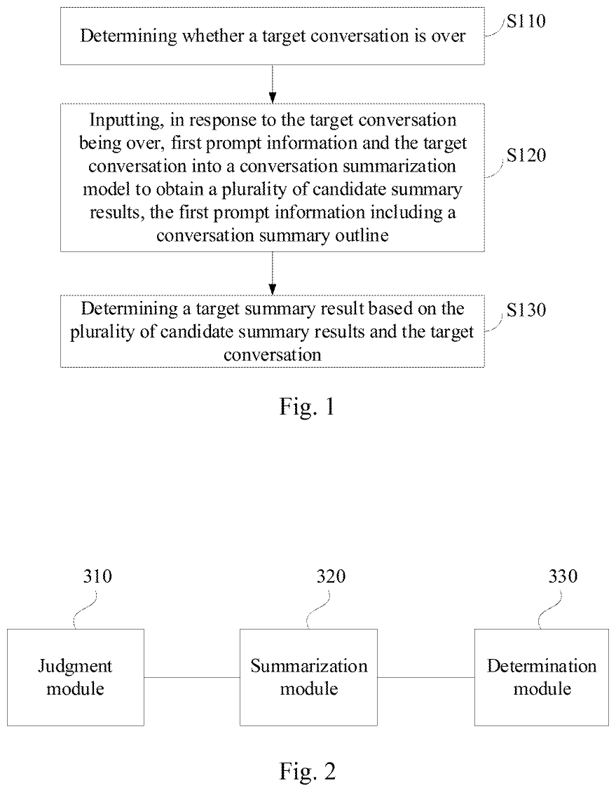

FIG. 1 is a flowchart of a conversation information processing method provided by at least one embodiment of the present disclosure. The at least one embodiment may be applied to a case where conversation information processing is performed in a client. The method may be executed by a conversation information processing apparatus, which may be implemented by software and/or hardware and may be configured in an electronic device, such as a terminal, specifically including but not limited to a smartphone, a palmtop computer, a tablet computer, a wearable device with a display screen, a desktop computer, a laptop computer, an all-in-one machine, a smart home device, etc. Alternatively, the at least one embodiment may be applied to a case where conversation information processing is performed in a server. The method may be executed by a conversation information processing apparatus, which may be implemented by software and/or hardware and may be configured in an electronic device, such as a server.

As shown in FIG. 1, the method may specifically include:
S110, determining whether a target conversation is over.

The target conversation may be, for example, a conversation to which the technical solution provided by the present disclosure is applied. The present disclosure does not limit the specific content of the target conversation. Exemplarily, the target conversation may be a health consultation conversation in the medical field, an educational planning consultation conversation in the educational field, etc.

Whether the target conversation is over may refer to, for example, that participants (such as both parties communicating) in the target conversation no longer continue to communicate and information exchange is terminated. Exemplarily, the target conversation is a health consultation conversation about a certain disease. In the health consultation conversation, a patient asks all questions and a doctor also answers all the questions, and neither party has a new topic to communicate about. At this time, it may be determined that the target conversation is over.

There are many implementation methods of this step, which is not limited in the present disclosure. Exemplarily, in at least one embodiment, an implementation method of this step may include: inputting the target conversation into a conversation end prediction model to determine whether the target conversation is over. The conversation end prediction model may be, for example, a pre-trained model capable of predicting whether a conversation is over.

In some scenarios, the conversation end prediction model may be a binary classification model. Exemplarily, the conversation end prediction model may be a binary classification model based on bidirectional encoder representations from transformers (BERT). A method for training the conversation end prediction model may include: acquiring sample data, where the sample data includes a sample conversation and labeling information corresponding to the sample conversation, the labeling information being used to reflect whether the sample conversation is over; inputting the sample conversation into a conversation end prediction model to be trained, to obtain first information, the first information reflecting a probability that the sample conversation is over; determining a loss function based on the first information and the labeling information corresponding to the sample conversation; and correcting a parameter in the conversation end prediction model based on the loss function, so as to continuously improve the accuracy of a prediction result of the conversation end prediction model. Optionally, the loss function may be a cross-entropy loss function.

Optionally, the labeling information corresponding to the sample conversation may further reflect information on whether the sample conversation needs to be summarized. The first information output by the conversation end prediction model includes a probability that the sample conversation needs to be summarized. This is because, in some scenarios, the sample conversation does not need to be summarized. For example, in the medical field, a conversation for health consultation needs to be summarized, while a conversation for disease popularization does not need to be summarized.

Further, inputting the target conversation into the conversation end prediction model to determine whether the target conversation is over may further include: extracting feature information of the target conversation up to a current moment; and inputting, in response to the feature information of the target conversation meeting a preset trigger condition, the target conversation into the conversation end prediction model to determine whether the target conversation is over.

The feature information of the target conversation may be, for example, information used to preliminarily determine whether the target conversation is over. The preset trigger condition may be, for example, a condition used to determine whether the target conversation is over. The present disclosure does not limit what the feature information of the target conversation is and what the preset trigger condition is. In practice, the preset trigger condition is associated with the feature information of the target conversation. Exemplarily, the feature information of the target conversation is a total number of words in the target conversation; and the preset trigger condition includes that the total number of words in the target conversation is greater than or equal to a preset number-of-words threshold. The feature information of the target conversation is a time interval between a sending moment of a last conversation message and the current moment; and the preset trigger condition includes that the time interval between the sending moment of the last conversation message and the current moment is greater than or equal to a preset duration.

The target conversation is input into the conversation end prediction model to determine whether the target conversation is over in response to the feature information of the target conversation meeting the preset trigger condition, so as to reduce the number of calls of the conversation end prediction model as much as possible. The reason for such setting is that each time the conversation end prediction model is called, it is necessary to analyze and process the input conversation content, which involves complex algorithm operations. In this process, the CPU or GPU needs to perform a large amount of computing work, consuming a large amount of computing power resources. Moreover, during the operation of the conversation end prediction model, conversation data, intermediate calculation results, model parameters, etc. need to be stored. With the increasing number of calls, the occupied memory space will also increase continuously, which easily leads to system memory tension.
S120, inputting, in response to the target conversation being over, first prompt information and the target conversation into a conversation summarization model to obtain a plurality of candidate summary results, the first prompt information including a conversation summary outline.

The first prompt information may be, for example, information that needs to be input into the conversation summarization model and used to control a summarization process of the conversation summarization model. The conversation summary outline may be, for example, a framework that highly summarizes the conversation content, which may include a text limitation on which aspects the target conversation is summarized from.

The conversation summarization model may be, for example, a model used to perform conversation information processing under the control of the first prompt information. Exemplarily, the conversation summarization model may be a large language model capable of semantic understanding. Exemplarily, the conversation summarization model may be a large language model based on a chain-of-thought (COT) strategy.

The candidate summary results may be, for example, summary results output by the conversation summarization model.

In practice, an implementation method of this step may include: inputting the same first prompt information and the target conversation into the conversation summarization model multiple times, and after each input, the conversation summarization model outputs a candidate summary result, and in this way, a plurality of candidate summary results may be finally obtained. Alternatively, a number of running rounds of the conversation summarization model is preset, the same first prompt information and the target conversation are input into the conversation summarization model, and the conversation summarization model is controlled to perform multiple rounds of conversation summarization. In each round, the conversation summarization model obtains a new candidate summary result based on the first prompt information and the target conversation. After such multiple rounds of operations, a plurality of candidate summary results may be obtained in total.

Optionally, an implementation method of this step may further include: inputting a plurality of pieces of different first prompt information and the target conversation into the conversation summarization model, respectively. After each input of the first prompt information and the target conversation, the conversation summarization model outputs a candidate summary result, and after multiple operations, a plurality of candidate summary results may be obtained in total. The candidate summary results are obtained based on different first prompt information. Optionally, differences between different pieces of first prompt information may include format differences, or expression differences formed by describing the same content using different words or word orders.

Further, the first prompt information may further include a format of the candidate summary result.

Exemplarily, in a health consultation scenario, the first prompt information is:

Please complete the following tasks step by step and generate a summary based on the complete conversation content of the medical consultation:
1. Extract basic information of the user. If not mentioned, mark as “unknown”.
2. Extract a main health problem (including symptoms and duration) described by the user.
3. Extract content of advice (such as lifestyle adjustments or suggestions).
4. Integrate the above content and generate a summary in the following format:
“Basic information”: “XXXX”
“Problem description”: “XXXX”
“Conclusion”: “XXXX”
“Advice”: “XXXX”.
S130, determining a target summary result based on the plurality of candidate summary results and the target conversation.

Optionally, an implementation method of this step may include: selecting the target summary result from the plurality of candidate summary results based on the target conversation. The summary result selection model may be, for example, a pre-trained model. Optionally, it may be a neural network model based on a self-consistency strategy.

In practice, the candidate summary results output by the conversation summarization model are random. This may make the correlation, consistency and coverage of each candidate summary result with the target conversation different. This step is essentially to screen the candidate summary results, so that the finally obtained target summary result has a higher correlation, a stronger coverage and a higher accuracy with the target conversation.

Further, an implementation method of this step may include: inputting the plurality of candidate summary results and the target conversation into a summary result selection model to obtain the target summary result.

Further, inputting the plurality of candidate summary results and the target conversation into the summary result selection model to obtain the target summary result may include: inputting the plurality of candidate summary results, the target conversation and second prompt information into the summary result selection model to obtain the target summary result, the second prompt information including a selection standard.

The second prompt information may be, for example, information that needs to be input into the summary result selection model and used to guide the summary result selection model to select the target summary result from the plurality of candidate summary results. The selection standard may be, for example, a feature that is expected to be possessed by the target summary result. Optionally, the selection standard includes content in at least one of the following aspects: a requirement on a correlation degree between the candidate summary result and the target conversation, a requirement on consistency between the candidate summary result and the target conversation, and a requirement on a coverage degree of the candidate summary result to the content of the target conversation.

Exemplarily, in the health consultation scenario, the second prompt information may be set as: please select the best summary according to the following standards: 1. whether a health problem description is accurate and complete and covers all key information mentioned in the conversation; 2. whether the advice is reasonable, specific and consistent with the content of the conversation; and 3. whether the summary logic is clear and the content is organized.

It should be noted that, in the prior art, corresponding summary templates need to be set for different conversation scenarios. These templates not only need to cover the key information in the scenario, but also need to ensure the accuracy and integrity of the information. However, in practical applications, the scenarios are rich, diverse, complex and changeable, and constructing and maintaining these complex templates is not only time-consuming and labor-intensive, but also may be difficult to fully cover due to subtle differences between scenarios or the emergence of new scenarios, for example, there is a scenario without a corresponding summary template.

The first prompt information (including the conversation summary outline) used in the technical solution of the present disclosure has stronger flexibility. It is not as fixed as the summary template, but may be flexibly adjusted according to the specific content and purpose of the conversation. For example, when facing consultations on different diseases, the key information actually involved in the conversation may be highlighted in the summary outline, to guide the conversation summarization model to generate summary content that better meets the requirements. In addition, the cost of setting the first prompt information is relatively low. There is no need to design a complex framework and a fixed slot for each scenario one by one like constructing the summary template, and only the conversation summary outline needs to be provided. In addition, the large language model as the conversation summarization model has a powerful language understanding and generalization ability, and by combining the first prompt information, it may better deal with complex semantics and logical relationships in the conversation. Even if the user does not directly and positively express a response to a question, the implied meaning may be understood according to the context of the user's conversation. Therefore, the technical solution provided by the present disclosure may be used to summarize more comprehensively and accurately without missing important information due to the limitation of the preset framework like the traditional template.

In summary, according to the above technical solutions, it is determined whether a target conversation is over; in response to the target conversation being over, first prompt information and the target conversation are input into a conversation summarization model to obtain a plurality of candidate summary results, the first prompt information including a conversation summary outline; and a target summary result is determined based on the plurality of candidate summary results and the target conversation. According to the technical solution provided by the present disclosure, the language understanding ability of a large language model is used to summarize conversation content. According to this solution, the purpose of summarization may be conveniently and quickly realized without setting complex summary templates for different conversation scenarios. Moreover, the provided target summary result has a high correlation and accuracy with the target conversation, and covers the content of the target conversation more comprehensively.

It may be understood that before using the technical solutions disclosed in the embodiments of the present disclosure, the user shall be informed of the type, range of use, use scenarios, etc. of personal information involved in the present disclosure and the authorization of the user shall be obtained in an appropriate manner in accordance with relevant laws and regulations.

For example, in response to receiving an active request from a user, prompt information is sent to the user to clearly prompt the user that the requested operation will need to access and use personal information of the user. In this way, the user may independently choose whether to provide the personal information to software or hardware, such as an electronic device, an application, a server or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also carry a selection control for the user to select “agree” or “disagree” to provide the personal information to the electronic device.

It may be understood that the above process of notifying and acquiring user authorization is only illustrative and does not limit the implementations of the present disclosure, and other methods that meet relevant laws and regulations may also be applied to the implementations of the present disclosure.

It should be noted that, for the sake of simple description, the foregoing method embodiments are all expressed as a series of action combinations, but those skilled in the art should know that the present disclosure is not limited by the described action order, because according to the present disclosure, certain steps may be performed in other orders or simultaneously. Secondly, those skilled in the art should also know that the embodiments described in the specification all belong to preferred embodiments, and the involved actions and modules are not necessarily required by the present disclosure.

FIG. 2 is a schematic structural diagram of a conversation information processing apparatus according to at least one embodiment of the present disclosure. The conversation information processing apparatus provided by the at least one embodiment of the present disclosure may be configured in a client or a server. Referring to FIG. 2, the conversation information processing apparatus specifically includes: a judgment module 310, configured to determine whether a target conversation is over; a summarization module 320, configured to, in response to the target conversation being over, input first prompt information and the target conversation into a conversation summarization model to obtain a plurality of candidate summary results, the first prompt information including an outline of a conversation summary result; and a determination module 330, configured to determine a target summary result based on the plurality of candidate summary results and the target conversation.

Further, the judgment module 310 is configured to: input the target conversation into a conversation end prediction model to determine whether the target conversation is over.

Further, the judgment module 310 is configured to: extract feature information of the target conversation up to a current moment; and input, in response to the feature information of the target conversation meeting a preset trigger condition, the target conversation into a conversation end prediction model to determine whether the target conversation is over.

Further, the feature information of the target conversation is a total number of words in the target conversation; and the preset trigger condition includes that the total number of words in the target conversation is greater than or equal to a preset number-of-words threshold.

Further, the feature information of the target conversation is a time interval between a sending moment of a last conversation message and the current moment; and the preset trigger condition includes that the time interval between the sending moment of the last conversation message and the current moment is greater than or equal to a preset duration.

Further, the determination module is configured to: input the plurality of candidate summary results and the target conversation into a summary result selection model to obtain the target summary result.

Further, the determination module is configured to: input the plurality of candidate summary results, the target conversation and second prompt information into the summary result selection model to obtain the target summary result, the second prompt information including a selection standard.

The conversation information processing apparatus provided by the at least one embodiment of the present disclosure may perform the steps performed by the client or the server in the conversation information processing method provided by the method embodiments of the present disclosure, and has the steps performed and beneficial effects, which are not repeated here.

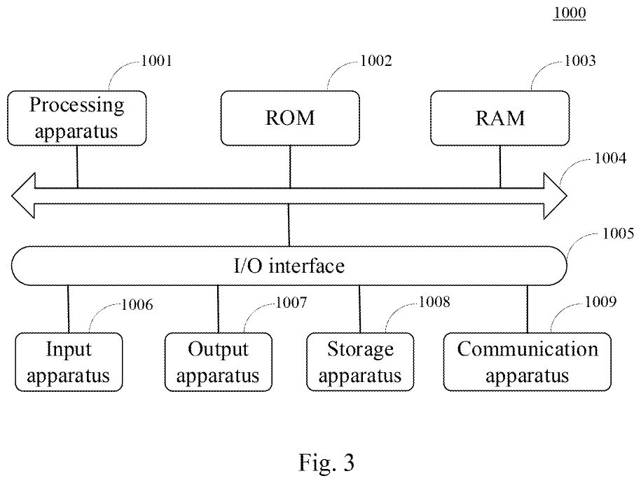

FIG. 3 is a schematic structural diagram of an electronic device according to at least one embodiment of the present disclosure. The following specifically refers to FIG. 3, which illustrates a schematic structural diagram of an electronic device 1000 suitable for implementing the embodiments of the present disclosure. The electronic device 1000 in the at least one embodiment of the present disclosure may include, but is not limited to, mobile terminals such as a mobile phone, a laptop computer, a digital broadcast receiver, a personal digital assistant (PDA), a tablet computer (PAD), a portable multimedia player (PMP), a vehicle-mounted terminal (such as a vehicle navigation terminal), and a wearable electronic device, and fixed terminals such as a digital TV, a desktop computer, and a smart home device. The electronic device shown in FIG. 3 is only an example, and should not impose any limitation on the function and scope of use of the embodiments of the present disclosure.

As shown in FIG. 3, the electronic device 1000 may include a processing apparatus (such as a central processing unit, a graphics processing unit, etc.) 1001, which may perform various appropriate actions and processing according to a program stored in a read-only memory (ROM) 1002 or a program loaded from a storage apparatus 1008 into a random access memory (RAM) 1003 to implement the conversation information processing method of the embodiments as described in the present disclosure. The RAM 1003 further stores various programs and information required for the operation of the electronic device 1000. The processing apparatus 1001, the ROM 1002 and the RAM 1003 are connected to each other through a bus 1004. An input/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; a storage apparatus 1008 including, for example, a magnetic tape and a hard disk; and a communication apparatus 1009. The communication apparatus 1009 may allow the electronic device 1000 to perform wireless or wired communication with other devices to exchange information. Although FIG. 3 shows the electronic device 1000 having various apparatuses, it should be understood that it is not required to implement or have all the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, the computer program containing program code for performing the method shown in the flowchart, thereby implementing the conversation information processing method as described above. In such at least one embodiment, the computer program may be downloaded and installed from a network through the communication apparatus 1009, or installed from the storage apparatus 1008, or installed from the ROM 1002. When the computer program is executed by the processing apparatus 1001, the above-mentioned functions defined in the method of the embodiments of the present disclosure are executed.

It should be noted that the above computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus or device. In the present disclosure, the computer-readable signal medium may include an information signal propagated in a baseband or as a part of a carrier wave, and computer-readable program code is carried in the information signal. The information signal propagated in this way may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program code contained on the computer-readable medium may be transmitted by any suitable medium, including but not limited to: a wire, an optical cable, a radio frequency (RF), etc., or any suitable combination of the above.

In some implementations, the client and the server may communicate using any known or future developed network protocol, such as the hypertext transfer protocol (HTTP), and may be interconnected with any form or medium of digital information communication (for example, a communication network). Examples of the communication network include a local area network (“LAN”), a wide area network (“WAN”), an internet (for example, the Internet), a peer-to-peer network (for example, an Ad-Hoc network), and any network known or to be developed in the future.

The computer-readable medium may be contained in the electronic device or may exist alone without being assembled into the electronic device.

The computer-readable medium carries one or more programs, which, when executed by the electronic device, cause the electronic device to: determine whether a target conversation is over; input, in response to the target conversation being over, first prompt information and the target conversation into a conversation summarization model to obtain a plurality of candidate summary results, the first prompt information including a conversation summary outline; and determine a target summary result based on the plurality of candidate summary results and the target conversation.

Optionally, when the one or more programs are executed by the electronic device, the electronic device may further perform other steps described in the above embodiments.

The computer program code for performing the operations of the present disclosure may be written in one or more programming languages or a combination thereof, the programming languages including but not limited to object-oriented programming languages such as Java, Smalltalk, and C++, and conventional procedural programming languages such as “C” language or similar programming languages. The program code may be executed entirely on a user computer, partly on a user computer, as a stand-alone software package, partly on a user computer and partly on a remote computer, or entirely on a remote computer or server. In the case of the remote computer, the remote computer may be connected to the user computer through any kind of network, including a local area network (LAN) or a wide area network (WAN), or it may be connected to an external computer (for example, connected by using Internet provided by an Internet service provider).

The flowchart and block diagrams in the drawings illustrate the architecture, functionality, and operation of possible implementations of systems, methods and computer program products according to various embodiments of the present disclosure. In this regard, each block in the flowchart or block diagrams may represent a module, a program segment, or a portion of code that includes one or more executable instructions for implementing a specified logical function. Furthermore, it should be noted that, in some alternative implementations, functions indicated in the blocks may occur in an order different from that indicated in the drawings. For example, two blocks shown in succession may, in fact, be executed substantially concurrently, or the blocks may sometimes be executed in the reverse order, depending upon the functionality involved. It also should be noted that each block of the block diagrams and/or flowchart, or a combination of blocks in the block diagrams and/or flowchart may be implemented in a special purpose hardware-based system that perform a specified function or operation, or may be implemented in a combination of special purpose hardware and a computer instruction.

The units involved in the embodiments described in the present disclosure may be implemented by software or by hardware. Among them, the name of a unit does not constitute a limitation on the unit itself under certain circumstances.

The foregoing functions described herein may be performed at least in part by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD) and more.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electrical, magnetic, optical, electromagnetic, infrared, or semi-conductive system, apparatus or device, or any suitable combination of the above. More specific examples of the machine-readable storage medium would include an electrical connection based on one or more wires, a portable computer disk, a hard disk, a random access memory (RAM), a read only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, the present disclosure provides an electronic device, including: one or more processors; and a memory, configured to store one or more programs, when the one or more programs are executed by the one or more processors, the one or more processors are caused to implement the conversation information processing method according to any one of the embodiments provided by the present disclosure.

According to one or more embodiments of the present disclosure, the present disclosure provides a computer-readable storage medium, on which a computer program is stored, and when the computer program is executed by a processor, the processor is caused to implement the conversation information processing method according to any one of the embodiments provided by the present disclosure.

At least one embodiment of the present disclosure further provides a computer program product, which includes a computer program or instructions, and when the computer program or instructions are executed by a processor, the conversation information processing method as described above is implemented.

It should be noted that in this paper, relational terms such as “first” and “second” are only used to distinguish one entity or operation from another entity or operation, and do not necessarily require or imply any actual relationship or order between these entities or operations. Moreover, terms “comprise”, “include” or any other variation thereof are intended to cover non-exclusive inclusion, so that a process, method, object or device including a series of elements includes not only those elements, but also other elements not explicitly listed or elements inherent to such process, method, object or device. Without further restrictions, an element defined by a phrase “including a” does not exclude that there are other identical elements in the process, method, object or device including the element.

The above descriptions are only specific implementations of the present disclosure, so that those skilled in the art may understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments described herein, but rather to the widest scope consistent with the principles and novel features disclosed herein.

1. A conversation information processing method, comprising:
obtaining, when a first conversation ends, a plurality of candidate summary results by inputting first prompt information and the first conversation into a conversation summarization model, the first prompt information comprising a conversation summary outline; and
outputting a first summary result based on the plurality of candidate summary results and the first conversation.

2. The method of claim 1, before the obtaining the plurality of the candidate summary results, the method further comprises:
obtaining whether the first conversation ends by inputting the first conversation into a conversation end prediction model.

3. The method of claim 2, wherein the obtaining whether the first conversation ends by inputting the first conversation into a conversation end prediction model comprises:
extracting feature information of the first conversation up to a current moment; and
obtaining, in response to the feature information of the first conversation meeting a trigger condition, whether the first conversation ends by inputting the first conversation into the conversation end prediction model.

4. The method of claim 3, wherein the feature information of the first conversation is a total number of words in the first conversation; and the trigger condition comprises that the total number of words in the first conversation is greater than or equal to a number-of-words threshold.

5. The method of claim 3, wherein the feature information of the first conversation is a time interval between a sending moment of a last conversation message and the current moment; and the trigger condition comprises that the time interval between the sending moment of the last conversation message and the current moment is greater than or equal to a duration.

6. The method of claim 1, wherein the outputting the first summary result based on the plurality of candidate summary results and the first conversation comprises:
obtaining the first summary result by inputting the plurality of candidate summary results and the first conversation into a summary result selection model.

7. The method of claim 6, wherein the obtaining the first summary result by inputting the plurality of candidate summary results and the first conversation into the summary result selection model comprises:
obtaining the first summary result by inputting the plurality of candidate summary results, the first conversation and second prompt information into the summary result selection model, the second prompt information comprising a selection standard.

8. An electronic device, comprising:
one or more processors; and
a storage apparatus, configured to store one or more programs,
wherein when the one or more programs are executed by the one or more processors, the one or more processors are caused to implement a conversation information processing method, and the method comprises:
obtaining, when a first conversation ends, a plurality of candidate summary results by inputting first prompt information and the first conversation into a conversation summarization model, the first prompt information comprising a conversation summary outline; and
outputting a first summary result based on the plurality of candidate summary results and the first conversation.

9. The electronic device of claim 8, before the obtaining the plurality of the candidate summary results, the method further comprises:
obtaining whether the first conversation ends by inputting the first conversation into a conversation end prediction model.

10. The electronic device of claim 9, wherein the obtaining whether the first conversation ends by inputting the first conversation into a conversation end prediction model comprises:
extracting feature information of the first conversation up to a current moment; and
obtaining, in response to the feature information of the first conversation meeting a trigger condition, whether the first conversation ends by inputting the first conversation into the conversation end prediction model.

11. The electronic device of claim 10, wherein the feature information of the first conversation is a total number of words in the first conversation; and the trigger condition comprises that the total number of words in the first conversation is greater than or equal to a number-of-words threshold.

12. The electronic device of claim 10, wherein the feature information of the first conversation is a time interval between a sending moment of a last conversation message and the current moment; and the trigger condition comprises that the time interval between the sending moment of the last conversation message and the current moment is greater than or equal to a duration.

13. The electronic device of claim 8, wherein the outputting the first summary result based on the plurality of candidate summary results and the first conversation comprises:
obtaining the first summary result by inputting the plurality of candidate summary results and the first conversation into a summary result selection model.

14. The electronic device of claim 13, wherein the obtaining the first summary result by inputting the plurality of candidate summary results and the first conversation into the summary result selection model comprises:
obtaining the first summary result by inputting the plurality of candidate summary results, the first conversation and second prompt information into the summary result selection model, the second prompt information comprising a selection standard.

15. A non-transitory computer-readable storage medium storing a computer program, wherein when the computer program is executed by a processor, the processor is caused to implement a conversation information processing method, and the method comprises:
obtaining, when a first conversation ends, a plurality of candidate summary results by inputting first prompt information and the first conversation into a conversation summarization model, the first prompt information comprising a conversation summary outline; and
outputting a first summary result based on the plurality of candidate summary results and the first conversation.

16. The storage medium of claim 15, before the obtaining the plurality of the candidate summary results, the method further comprises:
obtaining whether the first conversation ends by inputting the first conversation into a conversation end prediction model.

17. The storage medium of claim 16, wherein the obtaining whether the first conversation ends by inputting the first conversation into a conversation end prediction model comprises:
extracting feature information of the first conversation up to a current moment; and
obtaining, in response to the feature information of the first conversation meeting a trigger condition, whether the first conversation ends by inputting the first conversation into the conversation end prediction model.

18. The storage medium of claim 17, wherein the feature information of the first conversation is a total number of words in the first conversation; and the trigger condition comprises that the total number of words in the first conversation is greater than or equal to a number-of-words threshold.

19. The storage medium of claim 17, wherein the feature information of the first conversation is a time interval between a sending moment of a last conversation message and the current moment; and the trigger condition comprises that the time interval between the sending moment of the last conversation message and the current moment is greater than or equal to a duration.

20. The storage medium of claim 15, wherein the outputting the first summary result based on the plurality of candidate summary results and the first conversation comprises:
obtaining the first summary result by inputting the plurality of candidate summary results and the first conversation into a summary result selection model.
